(19) United States
(12) Patent Application Publication
(10) Pub. No.: US 2015/0162756 A1
(43) Pub. Date: Jun. 11, 2015

(54) BACK-UP POWER SUPPLY FOR MOBILE PHONE

(71) Applicant: Shenzhen Hello Tech Energy Co., Ltd., Shenzhen (CN)

(72) Inventor: Meichan Wen, Shenzhen (CN)

(73) Assignee: Shenzhen Hello Tech Energy Co., Ltd., Shenzhen (CN)

(21) Appl. No.: 14/205,452

(22) Filed: Mar. 12, 2014

(30) Foreign Application Priority Data
Dec. 11, 2013 (CN) 201320818017.9

(51) Int. Cl. H02J 7/00

(52) U.S. Cl. CPC H02J 7/007; H02J 7/0052; H02J 7/0047; H02J 2007/0095

(57) ABSTRACT

A mobile phone back-up power supply includes: a protection case configured to receive a mobile phone; a battery charging module detachably connected to the protection case; an interface terminal having one end electrically coupling to the charging module and having another end matching a charging interface of the mobile phone; and a terminal fixed at one end of the separation board covering the interface terminal. The battery charging module includes: a bottom housing defining a cavity; a battery received in the cavity; a charging module received in the cavity; and a separation board covering the charging module and the battery.

### FIELD OF THE INVENTION

The present disclosure relates to power supplies, and more particularly relates to a back-up power supply for a mobile phone.

### BACKGROUND OF THE INVENTION

As the continuous development and progress in wireless communication technology and semiconductor manufacturing technology, mobile phones, especially smart phones, are growing lighter and more compact and coming to have more functions. In fact, the mobile phone is nowadays an indispensable communication appliance in daily life. Although smart phones have become more and more powerful, it needs greater capacity battery, otherwise the battery is easily exhausted, unable to provide adequate long endurance. With the increasing mobile performance and larger screen, the standby time of the phone has become a big issue, which is also an obstacle to limit the development of the smart phones.

A back-up mobile charger is provided for electronic devices which can be easily carried to recharge the phone in the event of a low battery charge. However, the conventional mobile power usually employs a cable to connect the phone during use, which is very inconvenient. In addition, a back-up battery is not prone to be separated from the phone, thus increasing the thickness of the phone.

Therefore, there is room for improvement within the art.

### SUMMARY OF THE INVENTION

The present disclosure is directed to back-up power supply for mobile phone, which has a compact structure and can be easily separated from the phone.

A back-up power supply for mobile phone includes: a protection case configured to receive a mobile phone; a battery charging module detachably connected to the protection case via a latching assembly, the battery charging module includes: a bottom housing defining a cavity; a battery received in the cavity; a charging module received in the cavity, the charging module includes: a charging input interface configured to charge the battery; a charging management circuit configured to control the charging and discharging of the battery; and a boost circuit configured to elevate an output voltage of the battery to a required voltage for phone charging; and a separation board covering the charging module and the battery; an interface terminal having one end electrically coupling to the charging module and having another end matching a charging interface of the mobile phone; and a terminal cover fixed at one end of the separation board covering the interface terminal.

In one embodiment, the charging input interface is a Lightning connector or a Mirco-USB connector or a Mini-USB connector.

In one embodiment, the battery is a lithium battery or a polymer battery.

In one embodiment, the back-up power supply further includes an LED positioned at an end of the separation board, wherein the LED is electrically coupled to the charging module for displaying the remaining battery power and charging indicator.

In one embodiment, the latching assembly comprises a latching boss disposed on the separation board, the protection case defines a latching hole, the latching boss engages the latching hole.

In one embodiment, a cross-section of the latching boss has a “T” shape, the protection case comprises a stepped portion adjacent to the latching hole, the stepped portion engages the latching boss.

In one embodiment, the battery is coupled to the charging module by welding.

In one embodiment, the bottom housing is provided with a retaining clip for fixing the battery.

The back-up power supply can function both as the protection case and the mobile power, and it does not require any cables during use. The back-up power supply also has the features of compact structure, small size, easy to use and convenience.

These and other objects, advantages, purposes and features will become apparent upon review of the following specification in conjunction with the drawings.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding parts throughout the views.

FIG. 1 is a exploded perspective view of an embodiment of a back-up power supply for mobile phone;

FIG. 2 is a block diagram of a charging module of the back-up power supply of FIG. 1;

FIG. 3A to FIG. 3C illustrate an assembly process of the back-up power supply of FIG. 1;

FIG. 4A to FIG. 4C illustrate a disassembly process of the back-up power supply of FIG. 1.

### DETAILED DESCRIPTION OF THE EMBODIMENTS

Reference will now be made to the drawings to describe, in detail, embodiments of the present back-up power supply for mobile phone. It should be noted that references to “an” or “one” embodiment in this disclosure are not necessarily to the same embodiment, and such references mean at least one.

Unless the context clearly requires otherwise, throughout the description and the claims, the words “comprise,” “comprising,” and the like are to be construed in an inclusive sense as opposed to an exclusive or exhaustive sense; that is to say, in the sense of “including, but not limited to.” Words using the singular or plural number also include the plural or singular number respectively. Additionally, the words “herein,” “above,” “below” and words of similar import, when used in this application, shall refer to this application as a whole and not to any particular portions of this application. When the claims use the word “or” in reference to a list of two or more items, that word covers all of the following interpretations of the word: any of the items in the list, all of the items in the list and any combination of the items in the list.

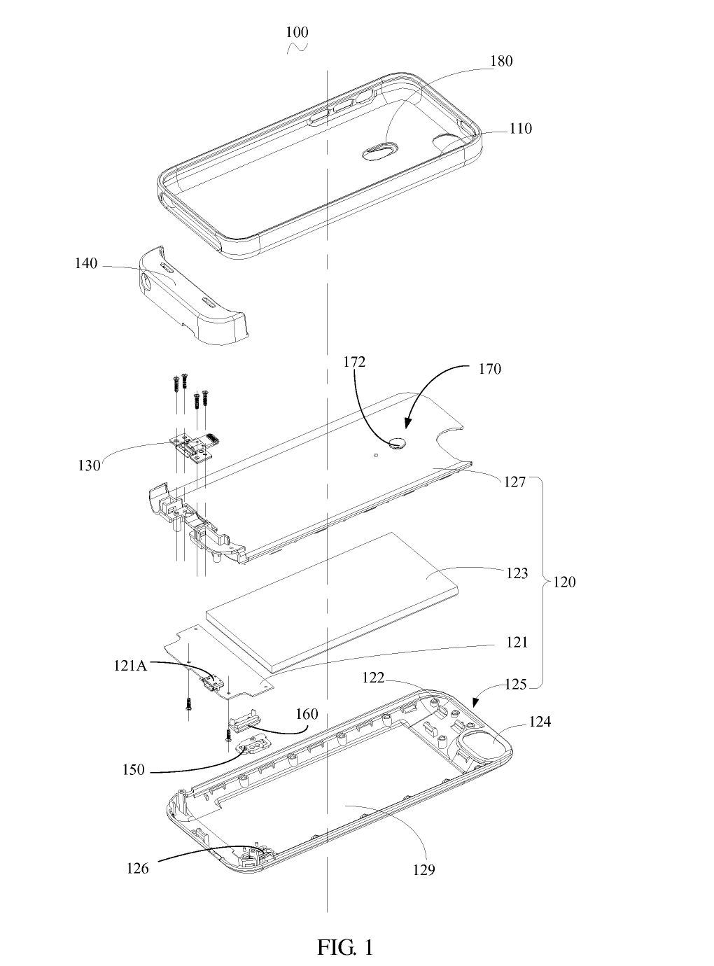

Referring to FIG. 1, an embodiment of a back-up power supply 100 may be applied to a mobile phone 200, which includes a protection case 110, a battery charging module 120, an interface terminal 130, a terminal cover 140, a button 150, a light guild column 160, and a latching assembly 170.

The protection case 110 is used to receive the mobile phone 200. The protection case 110 is made of plastic, metal, or leather.

The battery charging module 120 is detachably connected to the protection case 110 via the latching assembly 170. The battery charging module 120 includes a charging module 121, a battery 123, a bottom housing 125, and a separation board 127. The charging module 121 is electrically coupled to the battery 123. The battery 123 is a lithium battery or a polymer battery, and it is coupled to the charging module 121 by welding. The bottom housing 125 defines a cavity 129. The charging module 121 and the battery 123 are received in the cavity 129. The bottom housing 125 is provided with a retaining clip 122 for fixing the battery 123, thus facilitating the assembly of the back-up power supply 100. The bottom housing 125 further defines a through hole 124 corresponding to a camera lens of the mobile phone 200, such that the user can take photos while charging the mobile phone 200. The separation board 127 is mounted on the bottom housing 125 and covers the charging module 121 and the battery 123. The bottom housing 125 and the separation board 127 can be made of plastic, metal, or leather.

The bottom housing 125 further defines a mounting hole 126 adjacent to one end thereof. The button 150 is disposed on the bottom housing 125 and protrudes out of the mounting hole 126. The button 150 is connected to the charging module 121 and is used to switch on the power output to the mobile phone 200. A long pressure of the button 150 can activate the battery capacity inquiry. The light guild column 160 is placed adjacent to the button 150 and is used to display the current battery capacity.

The latching assembly 170 includes a latching boss 172 disposed on the separation board 127. The latching boss 172 has a substantially T-shaped cross-section. The protection case 110 defines a latching hole 180 corresponding to the latching boss 172. The protection case 110 further includes a stepped portion 182 adjacent to the latching hole 180. The latching boss 172 can be received in the latching hole 180 and engaged with the stepped portion 182.

The interface terminal 130 has one end electrically coupling to the charging module 121 and has another end matching a charging interface of the mobile phone 200. In the illustrated embodiment, the interface terminal 130 is a Lightning connector, which is a proprietary computer bus and power connector created by Apple Inc. to connect Apple mobile devices like iPhones, iPads and iPods to host computers, external monitors, cameras, USB battery chargers and other peripherals. The terminal cover 140 is fixed at one end of the separation board 127 and covers the interface terminal 130.

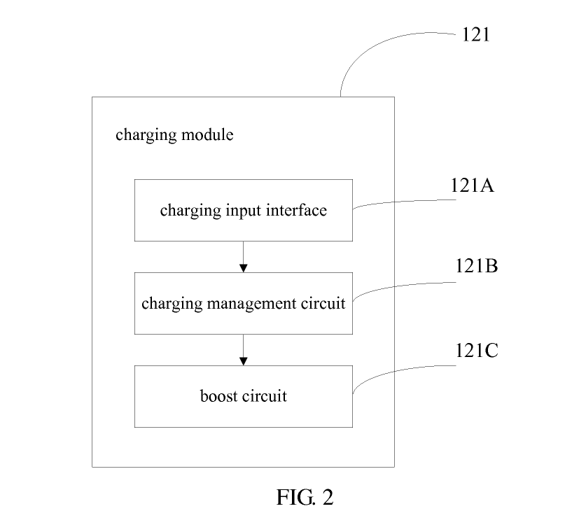

In one embodiment, referring to FIG. 2, the charging module 121 includes a charging input interface 121A, a charging management circuit 121B, and a boost circuit 121C.

The charging input interface 121A is connected to a power adapter for charging the battery 123. In the illustrated embodiment, the charging input interface 121A is a Mirco-USB connector. It should be understood that, in alternative embodiment, the charging input interface 121A may also be a Mini-USB connector or a Lightning connector.

The charging management circuit 121B is electrically coupled to the battery 123 and is configured to control the charging and discharging of the battery 123. The charging management circuit 121B can also test the battery capacity by means of voltage or current. The boost circuit 121C is electrically coupled to the battery 123 is configured to elevate an output voltage of the battery 123 to a required voltage for phone charging.

The back-up power supply 100 further includes an LED positioned at an end of the separation board 127. The LED is coupled to the charging module 121 and is used to display the remaining battery power and charging indicator.

In assembly, the interface terminal 130 is coupled to the charging module 121 via a flexible circuit board, then the battery 123 is welded to the charging module 121. The charging module 121 and the battery 123 are then fixed to the bottom housing 125 using bolts or double-sided adhesive. The button 150 and the light guild column 160 are fixed to the bottom housing 125 by hot melting. The separation board 127 is mounted on the bottom housing 125, then the terminal cover 140 is mounted, and the protection case 110 is detachably connected to the battery charging module 120 via the latching assembly 170, the assembly of the back-up power supply 100 is thus completed.

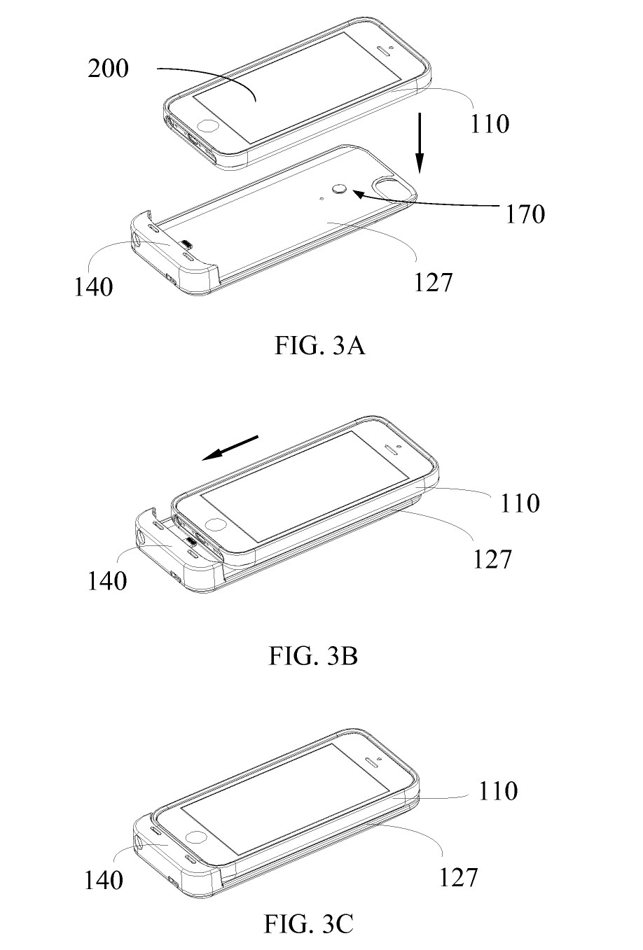

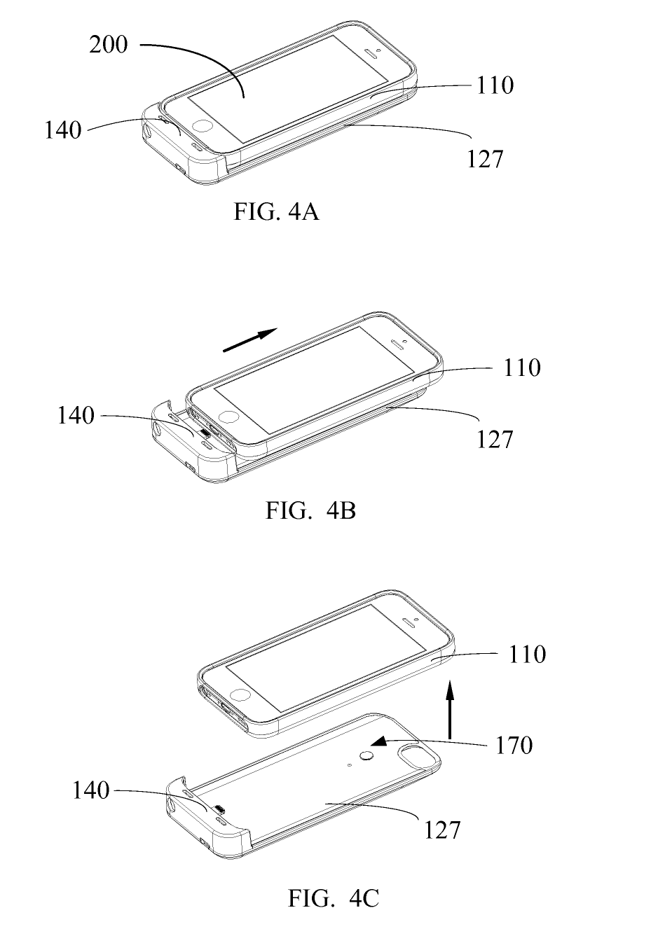

Referring to FIG. 3A to 3C, in use, the mobile phone 200 is placed inside the protection case 110, then the latching boss 172 on the separation board 127 is slidably received in the latching hole 180 on the protection case 110, while the charging interface of the mobile phone 200 is connected to the interface terminal 130, such that the protection case 110 is fixed with the battery charging module 120, and the mobile phone 200 is ready to be charged by the back-up power supply 100. Referring to FIG. 4A to 4C, after charging is completed, the protection case 110 with the mobile phone 200 can be removed from the battery charging module 120 by sliding along the separation board 127. Since only the protection case 110 with small thickness is sleeved on the phone, the beauty of the phone itself is remained while the protection of the phone is achieved.

The back-up power supply 100 can function both as the protection case and the mobile power, and it does not require any cables during use. The back-up power supply 100 also has the features of compact structure, small size, easy to use and convenience.

Although the present invention has been described with reference to the embodiments thereof and the best modes for carrying out the present invention, it is apparent to those skilled in the art that a variety of modifications and changes may be made without departing from the scope of the present invention, which is intended to be defined by the appended claims.

What is claimed is:

1. A back-up power supply for mobile phone, comprising:
a protection case configured to receive a mobile phone;
a battery charging module detachably connected to the protection case via a latching assembly, the battery charging module comprising:
a bottom housing defining a cavity;
a battery received in the cavity;
a charging module received in the cavity, the charging module comprising:
a charging input interface configured to charge the battery;
a charging management circuit configured to control the charging and discharging of the battery; and
a boost circuit configured to elevate an output voltage of the battery to a required voltage for phone charging; and
a separation board covering the charging module and the battery;
an interface terminal having one end electrically coupling to the charging module and having another end matching a charging interface of the mobile phone; and
a terminal cover fixed at one end of the separation board covering the interface terminal.

2. The back-up power supply according to claim 1, wherein the charging input interface is a Lightning connector or a Mirco-USB connector or a Mini-USB connector.

3. The back-up power supply according to claim 1, wherein the battery is a lithium battery or a polymer battery.

4. The back-up power supply according to claim 1, further comprising an LED positioned at an end of the separation board, wherein the LED is electrically coupled to the charging module for displaying the remaining battery power and charging indicator.

5. The back-up power supply according to claim 1, wherein the latching assembly comprises a latching boss disposed on the separation board, the protection case defines a latching hole, the latching boss engages the latching hole.

6. The back-up power supply according to claim 5, wherein a cross-section of the latching boss has a “T” shape, the protection case comprises a stepped portion adjacent to the latching hole, the stepped portion engages the latching boss.

7. The back-up power supply according to claim 1, wherein the battery is coupled to the charging module by welding.

8. The back-up power supply according to claim 1, wherein the bottom housing is provided with a retaining clip for fixing the battery.
